(19) United States
(12) Patent Application Publication
(10) Pub. No.: US 2007/0000195 A1
(43) Pub. Date: Jan. 4, 2007

(54) Decorative lattice structure and methods for manufacturing and installing same

(76) Inventors: Christian Garces, Austin, TX (US); Thomas Von Schimonsky, Elgin, TX (US)

Correspondence Address: Andrew G. DiNovo;JENKENS & GILCHRIST, A PROFESSIONAL CORPORATION, Suite 2500, 401 Congress Ave, Austin, TX, 78701, US

(21) Appl. No.: 11/417,776

(22) Filed: May 3, 2006

Related U.S. Application Data
(60) Provisional application No. 60/677,167, filed on May 3, 2005.

(51) Int. Cl. E06B 3/964; E04C 2/42; E04F 19/10

(52) U.S. Cl. 52/204.61; 52/311.3; 52/660

(57) ABSTRACT

A decorative lattice that simulates the look and feel of decorative ironwork by combining carving techniques and coating techniques is described. The decorative latticework is made of a sheet material such as a composite wood/fiber board material. The decorative lattice is suitable for a mass customization manufacturing processes.

### FIELD OF THE INVENTION

The present invention relates to a new decorative lattice structure that replicates traditional ironwork (cast iron, forged iron, wrought iron, welding or a combination of such techniques) for use as a major decorative element in window/door treatments, niches, wall and ceilings coverings, house trimming elements, and furniture/cabinetry accent elements and a method for producing and mounting such structures.

### BACKGROUND OF THE INVENTION

Existing products found in the window/door treatment market consists of: shutters, curtains, blinds, and cornices. In addition, but in a more limited way (typically in older/antique constructions), one may also encounter wood latticework, and ironworks (e.g. wrought or cast iron works).

Shutters and blinds are not well suited for all geometries of windows, especially windows that are not rectangular because their basic design elements are vertical or horizontal slats, bars, or foils which do not adapt well, if at all, to arched or irregular shapes. For the same reason, design options for shutters and blinds are also very limited, diminishing the possibility of design innovation and/or variety.

Typical wood lattices are also very limited in design alternatives as they are composed of slats assembled into a grid like configuration allowing only for limited and simple design options and only suited for regular shaped geometries.

Decorative ironworks have traditionally been permanently affixed to the outside structure of windows terraces (e.g. as balusters), stairways, and main entrance doors. They are typically associated with historical, artistic, and/or luxurious architecture. Their use as a mainstream/common interior design or architectural element has been limited because of its high manufacturing cost, skilled labor requirement, great customization requirements, and installation limitations and difficulties (e.g., heavy weight and difficulty to adjust pieces at the installation site in case they do not exactly fit the desired/required shape/dimensions). Also, traditional ironwork techniques are not well suited for modem automated production techniques (which are able to produce custom/low unit products using quasi mass production systems). In addition, because of its heavy weight, most ironwork used as a window treatment solution is typically installed to a building structure in a permanent manner and therefore this installation is usually limited to outside mounting, thus reducing the decorative potential for inside use.

Muntin bars (also called a windowpane divider or grille) are also used in windows and doors to perform a limited decorative function. They consist of short or light bars, either vertical or horizontal, used to separate glass in a sash into multiple lights. Modem windows and doors incorporate and replicate the design features of the Muntin bars by attaching a Muntin elements to one or both sides of the glass panes or by placing the Muntin bars sandwiched between glass panes. Muntin bars are very limited in design options (mainly as a grille) and are not made to replicate traditional decorative ironworks.

As with windows/door treatment, decorative ironworks have had a limited use in a variety of other decorative applications such as wall decoration, ceiling decoration (e.g. medallions), wall trimming (molding), niches, room dividers, bed headboards, and a variety of furniture/cabinetry accent elements. As with the window/door treatment industry this limitation is due to the high production costs involved as well as the installation limitation due to the weight/density of the material. Most decorative ironwork elements available are mass-produced/repetitive items rather than unique/custom items.

The assembly of simple design elements (typical these design elements are in a grid pattern such as in Muntin bars) between glass panel for the use in doors and window seems to be quite common in the market.

U.S. Pat. No. 5,418.021. Makes use of a tinted-glass layer sandwiched between two clear, transparent glass panes. This invention is inherently limited in Design option (using simple geometric elements), and is not made to replicate decorative ironwork.

U.S. Pat. No. 6,415,579. Makes use of non-metallic Muntin for use in hermetically sealed insulated glass windows. This invention is also limited in design options and is also not intended to replicate decorative ironwork.

Other patents describe the use of Muntin bars within glass pane assemblies such as U.S. Pat. No. 5,313,761 issued to Leopold, U.S. Pat. No. 4,783,938 issued to Palmer, U.S. Pat. No. 4,989,384 issued to Kinghom at al, U.S. Pat. No. 3,300,8593 issued to Smith, U.S. Pat. No. 4,204,015 issued to Wardlaw at al, and U.S. Pat. No. 4,652,472 issued to Davies. However, all of these inventions describe geometric and simple crossing bars designs which replicate Mutin bars. Other patents such as U.S. Pat. No. 6,272,801 issued to Suh and U.S. Pat. No. 5,494,715 issued to Glover also try to replicate the look of lead cames or glass solder. Again, all of the inventions listed describe make use of simple design elements and do not intend to replicate decorative ironwork.

The use of Powder Coating techniques have been available for many years in the coating/painting of metallic materials. Recently the technique has been adapted for the painting/coating of wood and wood composite materials. This makes use of powder coating materials that fuse at much lower temperature (higher temperatures would damage non metallic materials). However, there has been no use of such technology in manufacturing decorative lattices as described herein.

Summary: By reviewing the prior art one can clearly identify the need in the window/door treatment market as well as in the overall interior decorating market for a cost effective solution that allows for some or all of the following advantages, depending on the embodiment of the invention selected:

The look an feel of decorative ironwork (wrought, forged, cast, or combination thereof);

Variety, flexibility, and options in design;

Variety, flexibility of overall geometry and dimensions;

High cost look (e.g., Custom Wrought Iron) at a lower mass production cost;

Ease of installation and removal;

Rapid production time vis-à-vis its highly customizable design features;

High level of customization—almost infinite number of designs, shapes/geometries with minimum incremental production cost.

Employment of cost effective manufacturing techniques (quasi mass production techniques) while dealing with low unit (e.g. one of a kind) production/customized pieces;

Light weight when compared to the material it is replicating (e.g., Iron);

Suitable for inside installation;

The use of materials that can be easily cut/sanded thus allowing for easy adjustments to the decorative pieces at the installation site whenever there are small discrepancies between the piece and the geometry/size in which it is to be installed (such as in window and niche openings)

Variety of mounting techniques;

Installation to ceilings and walls with little or no retrofitting or reinforcing requirements to existing construction (Because of its light weight);

Hand carving of sheet material such as wood or plaster involves some techniques known to persons of skill in the art. These techniques are used in the Middle East (e.g., Morocco), Asia (e.g., India), and South America (e.g., Colombia) in the production of decorative pieces. However, the resulting pieces do not look like ironwork (cast or wrought iron). That is, there is no intent by the artists/craftsmen to replicate iron works. From the look and feel of the resulting art a person of skill in the art can discern that the material employed is wood or plaster. Also, the techniques used are not mechanized or automated and are heavily reliant on the artistic skill of the individual carver.

### SUMMARY OF THE INVENTION

The primary purpose and focus of the decorative lattice structure of the present invention is to provide a customizable decorative solution that replicates the look and feel of traditional decorative ironwork. This decorative lattice structure can be used as decorating solution for windows, doors, cornices, room dividers, niches, walls, ceilings, room dividers, furniture/cabinetry elements, as well as a stand-alone decorative element.

Embodiments of the present invention may be purchased and used by, e.g., homeowners, business owners, builders, architects and interior designers

### BRIEF DESCRIPTION OF THE DRAWINGS

The foregoing and other advantages of the invention will become apparent upon reading the following detailed description and upon reference to the drawings, wherein:

FIG. 1 illustrates a decorative lattice structure in accordance with the present invention.

FIG. 2A, 2B, 2C illustrate how a specific design (FIG. 2A) is adjusted and modified to work within the provided shape and dimensions (FIG. 2B) in order to obtain the desired decorative lattice (FIG. 2C);

FIG. 3A, 3B, 3C illustrate a design that has been manipulated into three different shapes/geometries: square (FIG. 3A), round (FIG. 3B), arched rectangle (FIG. 3C);

FIG. 4 illustrates some curl and scroll design elements the invention makes use of in order to replicate similar elements typically found in ironworks;

FIG. 5 illustrates additional design elements the invention makes use of in order to replicate similar elements typically found in ironworks: rings (1), weaves (2), wrap-around band (3), and wrap-around bracket (4);

FIG. 6 illustrates additional design elements the invention makes use of in order to replicate similar elements typically found in ironworks: acanthus leaves (5), vines (6), flowers (7), leaves (8), fans (9), and rosettes (10);

FIG. 7 illustrates additional design elements the invention makes use of in order to replicate similar elements typically found in ironworks: bars or balusters (11), knobs (12), crosses (13), fleur-de-lis (14), and spear points (15);

FIG. 8A illustrates the tool path that generates the inside accent cuts. Cutting the parallel lines (16) is the first step into replicating a wrap around bracket (17);

FIG. 8B illustrates the tool path that generates the outside/perimeter accent cuts;

FIG. 8C illustrates the tool path on the outside perimeter that cuts out the element from the original material;

FIG. 9A, 9B illustrate two examples of carving techniques which help replicate the effect and elaborate 3D look of cast, forged, or wrought iron : Two parallel carving lines (18) defining two overlapping elements (FIG. 9A), and a single carving line (19) defining two intersecting elements (FIG. 9B);

FIG. 10 illustrates the different tool bits used in creating the accent and/or countour carvings: “V-shaped” (20), “Roundover” (21), “Pointed Roundover” (22), “Roundnose” (23), and “Ogee” (24);

FIG. 11 illustrates how the carving can be performed on both sides of the board: Front side (25) and back side (26);

FIG. 12A, 12B, and 12C illustrate how the negative spaces (27) of the designs are cut out using the centerline of the initial contour accent carving as its boundary line (28) making use of a straight or spiral cylindrical bit (29) which cuts through the entire thickness of the material freeing the desired design element (30) from the raw material;

FIG. 13 illustrates how the decorative lattice (33) is cut out from its original board (31) along the lattice's outside contour (32);

FIG. 14 illustrates an alternative embodiment of the decorative lattices which are designed and manufactured with accent carvings (34) only. In this alternative embodiment the negative spaces (35) are not cut-out;

FIG. 15A illustrates a preferred embodiment for mounting the decorative lattice within a frame makes use of threaded metallic inserts and hex setscrews assemblies (36) placed around the frame of the decorative lattice structure (37) to anchor the product to the frame/structure of the window or niche (38);

FIG. 15B and 15C illustrate the threaded metallic inserts (40) and hex set screw (39) assembly in detail. It shows how the hex set screws (39) can be turned clockwise until they enter into the window (or niche) frame (38). It shows how the hex set screw head (41) is inserted into the hole (43) until it becomes flush with the lattice frame (37). It also shows how a hex key (42) is used for driving the hex set screw (39).

FIG. 16A and 16B illustrates a preferred embodiment in which the decorative lattice is employed as window cornice. It consists of a main/front cornice element (44) mounted over two or more perpendicularly mounted “return elements” (45). The “return elements” are mounted to the window frame (46). It also depicts the mechanical link between the “return elements” (45) and the main cornice element (44) using a keyhole hangers (47) (also known as “Keyhole fittings”) and a screw (48). The assembly occurs when the screw head (49) is introduced into the keyhole fitting (47) and slid down to lock the screw into position. An additional L bracket (50) is used to reinforce the assembly for larger pieces;

FIG. 17A, 17B illustrate another embodiment for mounting decorative lattices as window cornices. It consists of a two-part assembly: a mounting board (51) that is attached above the window frame (52), and a decorative lattice element (53). The decorative lattice element (53) is assembled over the mounting board (51). The mechanical link between (53) and (51) is achieved by using “Z-Clip panel hangers,” (54) “Interlocking Flush mount panel hangers,” or similar hardware;

FIG. 18A illustrates another embodiment of the invention in which the decorative lattice (55) is sandwiched between glass panes (56). A frame (57) holds the glass assembly together and also provide for an airtight seal of the interior of the assembly;

FIG. 18B illustrates a lattice-glass assembly (58) as part of a door assembly (59)

FIG. 19 illustrates a light filtering and/or blocking material (60) attached to the back of a decorative lattice (61);

FIG. 20 illustrates a light diffusing material (62) attached to the back of a decorative lattice (63);

FIG. 21 illustrates a decorative lattice (64) assembled in place of shutter louvers. The decorative lattice is assembled so that it is bordered by the shutter stiles (65) and shutter top (66) and bottom rails (67). The Figure also depicts a curved decorative lattice (69) assembled within the frame of a curved shutter component (68);

FIG. 22 illustrates decorative lattices (73) being used as a decorative accent/overlay element affixed over furniture/cabinetry panels (72), doors (70), or cornices (71);

FIG. 23A illustrates how various baluster elements (74) and horizontal rail elements (75) are individually cut. These elements include notches (76) that facilitate further assembly into more complex pieces; and

FIG. 23B illustrates the final assembly of the elements shown on FIG. 23A—a replica of a wrought iron balcony with protruding balusters. The physical linkage between the elements by connecting the individual elements' notches (77) is also shown.

FIG. 24A depicts a sliding decorative lattice over a window frame. A multi channel track (78) is assembled over a window frame (80). Wheel hangers (79) are assembled on the lattice (81) upper frame. The wheel hangers (79) are assembled on the tracks (78);

FIG. 24B depicts a sliding decorative lattice that functions as a room divider. A multi channel track (82) is assembled on the ceiling or beam (84) of a room. Wheel hangers (83) are assembled on the lattice (85) upper frame. The wheel hangers (83) are assembled on the tracks (82).

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention.

### DESCRIPTION OF ILLUSTRATIVE EMBODIMENTS

The invention in a preferred embodiment is a highly customizable lattice like material used primarily in (but not limited to) window treatment/decoration applications. The invention is also used as a decorative solution for cornices, room dividers, niches, wall decoration, door inserts, ceiling decorations (e.g., medallions), stand alone decoration, headboards, furniture accent elements among various other applications in which the feel and look of decorative ironwork and the flexibility of shapes and sizes is desired.

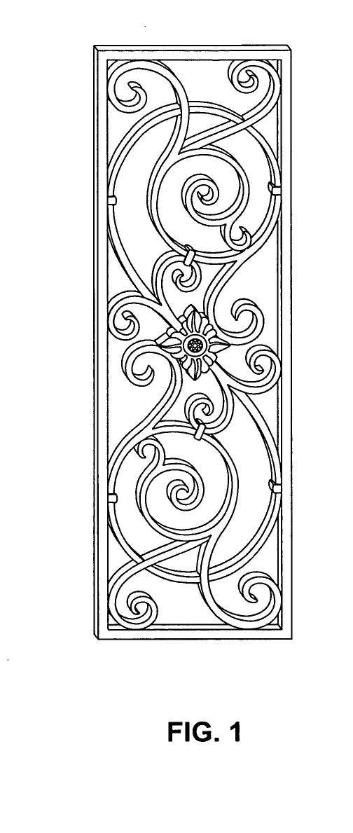

Preferred embodiments of the invention simulate the look and feel previously obtained in traditional crafted ironwork (including, e.g., wrought iron works, cast iron works, or the combination thereof). It can replicate or simulate design features and manufacturing techniques that conventionally use materials such as iron, steel, bronze or other metals in combination with fabrication techniques such as casting, forging, bending, turning, welding, soldering, riveting, injection molding, and gluing. (FIG. 1).

Base Material

Decorative lattice structures of the present invention are made preferably of composite materials—i.e., a mix of natural fibers and resins. One such material is a high-density fiberboard that is formaldehyde free. When the product application is for outside use a material with a high wax and some zinc content is used to make it waterproof as well as rot and termite resistant. Other natural materials, synthetic materials (e.g., plastics such as ABS, PVC), composite plastic, composite materials that include metal layers, or a combination of such materials can also be used in the production of decorative lattice work.

In a preferred embodiment the base material used comes as flat sheets/boards with a standard thickness of ¾″. There are other “standard” thickness depending on its applications that can be used included ¼″, ⅜″, ½″, ⅝″, ½″ and 1 1/2″. The typical/standard sizes of such sheet materials are 4′×8′and 5′×10′. Many other thickness and sizes can be employed for the production of the invention.

Design

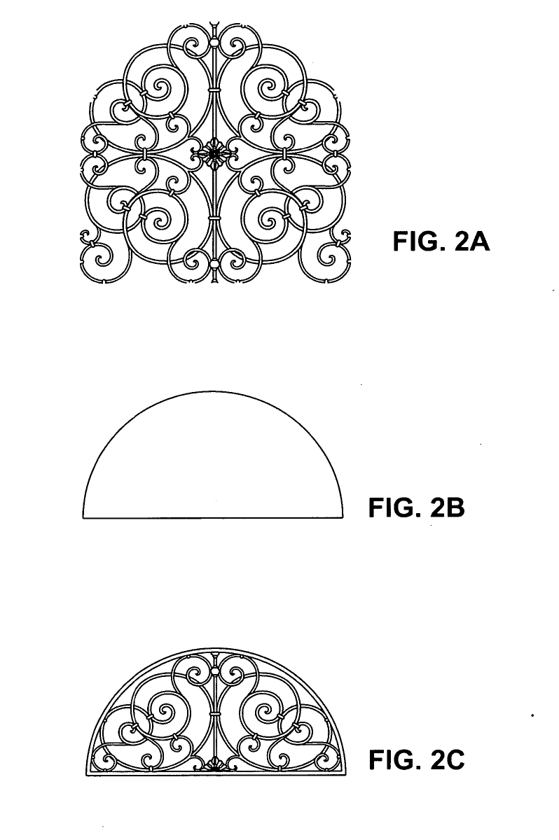

Typically, the decorative lattice structure production begins with a design selection either from a list of existing designs or a design provided by the customer. Preferably utilizing an engineering (e.g., CAD) or a publishing drafting software, the desired design (FIG. 2A) is adjusted and modified to work within the provided shape and dimensions (FIG. 2B) in order to obtain the desired decorative lattice (FIG. 2C). The resulting design is saved as vector art and added to the database of designs.

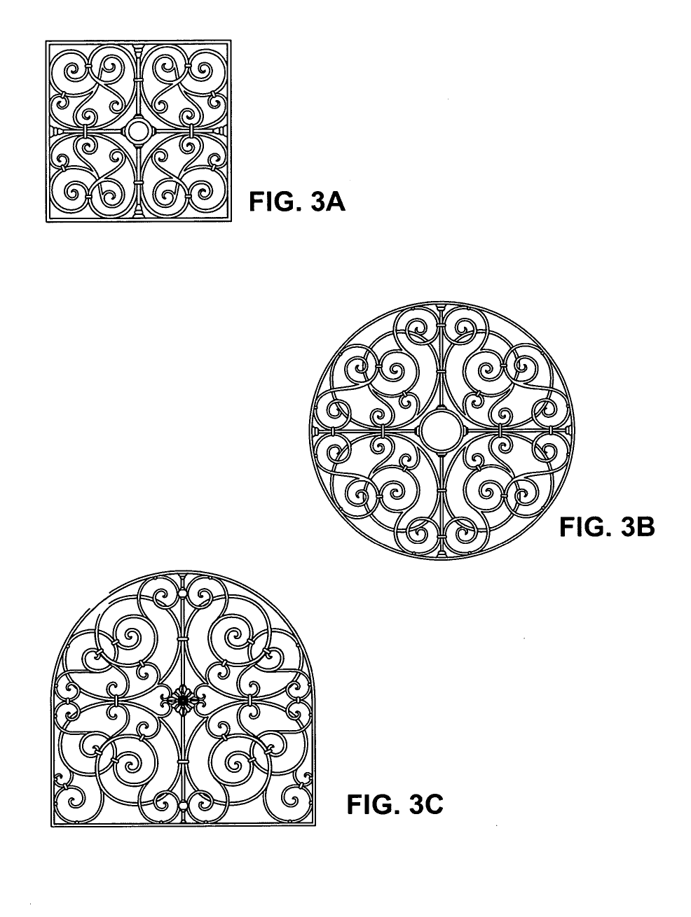

The CAD techniques allow for easy manipulation of designs in order to adapt the desired design to a specific shape and/or dimension as specified by the client. Each design can be adjusted/manipulated to adapt to specific shapes and geometry by a combination of techniques such as stretching or contracting design elements, reshaping design elements, copying and deleting design elements, and adding new design elements. FIGS. 3A, 3B, and 3C depict the same design that has been manipulated into 3 different shapes/geometries: square (FIG. 3A), circle (FIG. 3B), and arched rectangle (FIG. 3C). The invention allows for a build up of a design database that includes different versions (shape and dimensions) of the same design in addition to a database of design elements that are used to adapt a design to certain geometry and or dimension. All of these techniques are executed in a way that allow the original “spirit” of the design to persist after such modifications are implemented and retain the correct dimensional proportions.

Carving and Cutting

The digital design can then be tooled using Computer Aided Manufacturing (CAM) techniques to generate a series of cutting instructions (also known as G-code) for a Computerized Numeric Control (CNC) Router Table or Milling Table. The decorative lattice is machined in a sequence of steps leaving a lattice type product in its raw form. A person of ordinary skill in the art would understand that other sorts of automated or semi-automated cutting devices could also be utilized.

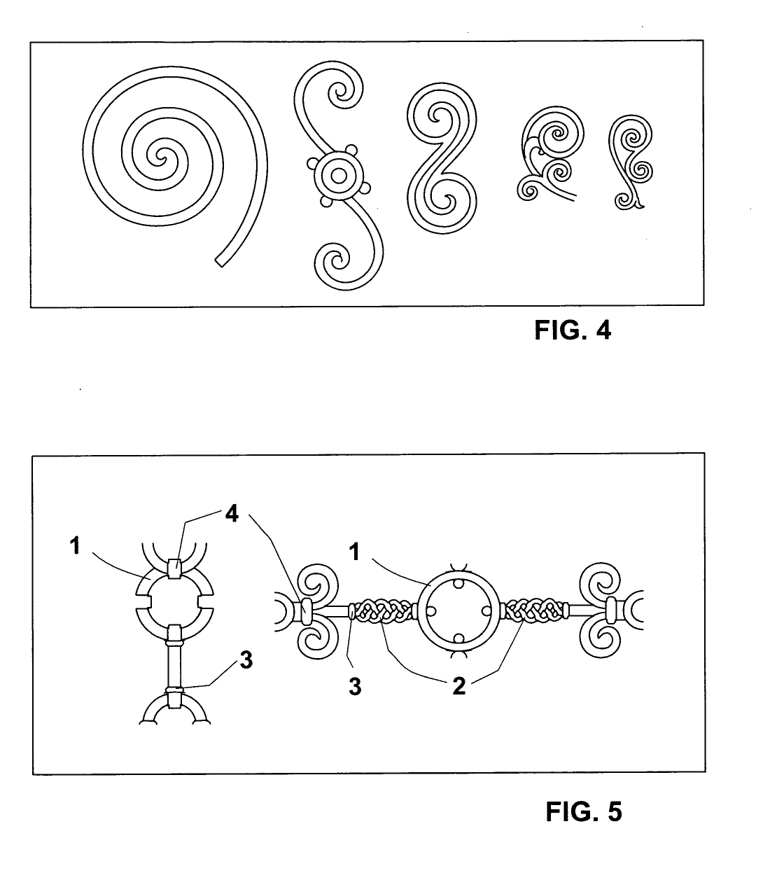

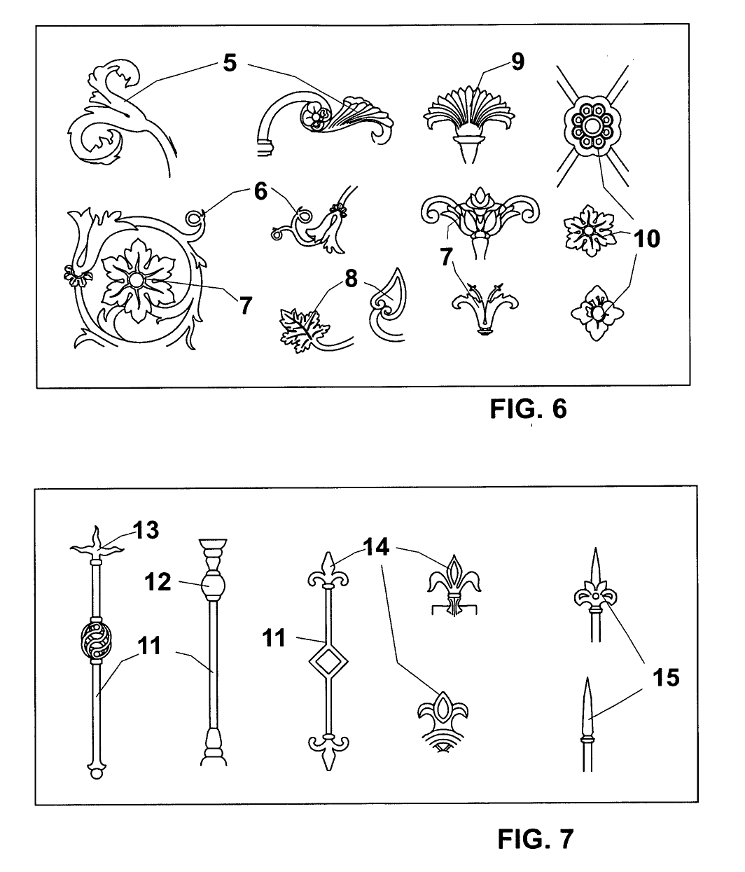

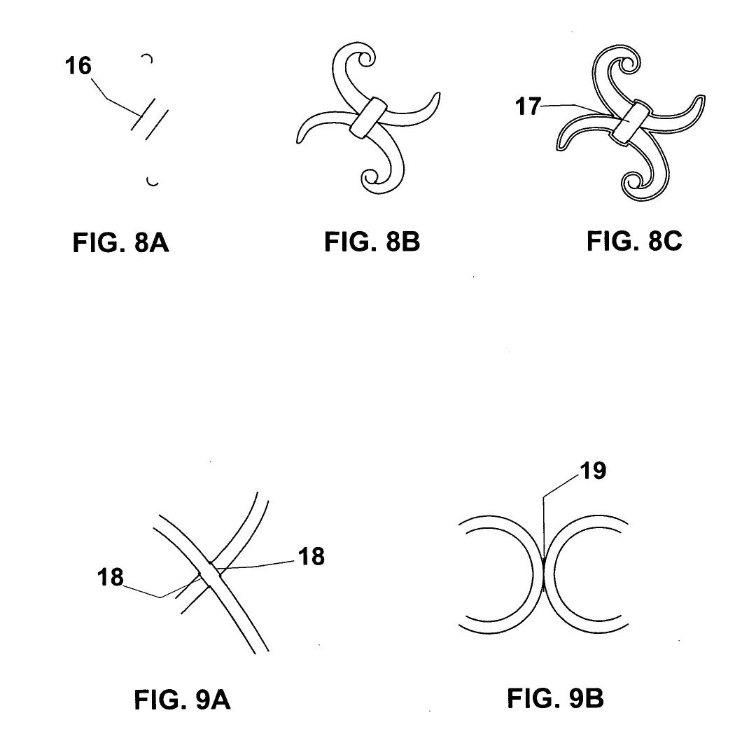

The invention makes use of design elements or replicated design elements typically found in ironworks e.g., scrolls and curls (FIG. 4); rings (1), weaves (2), ring wraps (3), and ring tabs (4) (FIG.5); acanthus leaves (5), vines (6), flowers (7), leaves (8), fans (9), and rosettes (10) (FIG.6); bars or balusters (11), knobs (12), crosses (13), fleur-de-lis (14), and spear points (15) (FIG. 7) and the like by carving and cutting them into the board/sheet material. This cutting/carving process is usually done in two steps. First an inside accent carve cut (FIG. 8A) (typically using a v-shaped cutting tool) is carved (in varying depths but typically less then the board thickness) into the material defining the inside accent lines. Second, and accent cut (typically using a v-shaped cutting tool) is carved (in varying depths but typically less then the board thickness) into the material defining the outline contour of the desired design elements (FIG. 8B). Third, the element is cut out when a cylindrical cutting tool cuts through the entire depth of the board material following the outside contour of the element (FIG. 8C).

The carved accents help replicate the effect and elaborate 3D look of cast, forged, or wrought iron.

FIGS. 8A, 8B, and 8C also show how the invention replicates the effect of a band/ring bracket typically used to link two elements in wrought iron pieces, the invention utilizes two parallel carvings (16) which give the depth appearance that replicates the effect of that band/ring (17).

FIGS. 9A and 9B depict another function of the accent carving which is to give the illusion of continuity for design elements that cross (FIG. 9A) or touch/intersect (FIG. 9B) each other. The two parallel carving lines (18) replicate the effect of overlapping element, the carving line (10) replicated the effect of two element touching each other.

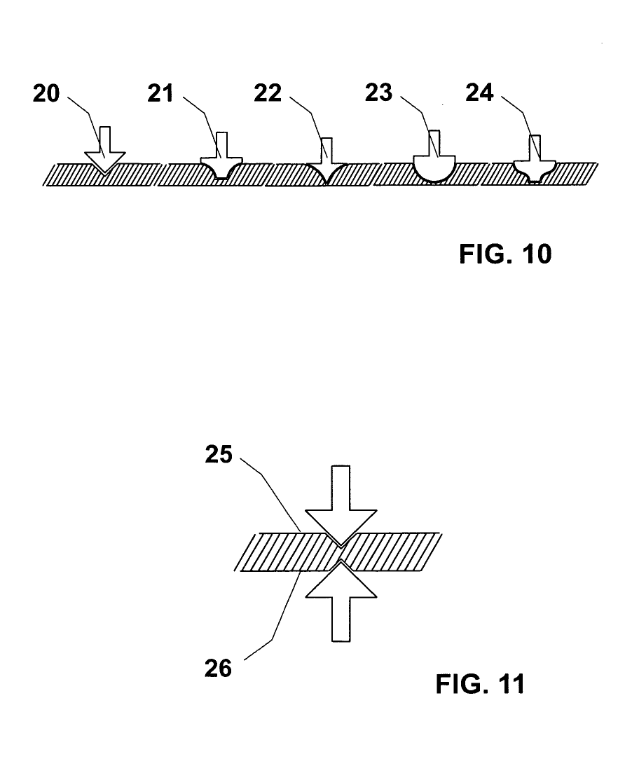

In addition to the “V-shaped” (20) cutting tools one can also employ “Roundover” (21) “Pointed Roundover” (22), “Roundnose” (23), “Ogee” (24), or any combination of such bit types (FIG. 10).

Optionally the same outline contour carvings and accent carvings performed on the front of the board (25) can be performed on the back side of the board (26) being cut. In this embodiment the decorative lattice can have the exact same design features on either side of the board. (FIG. 11).

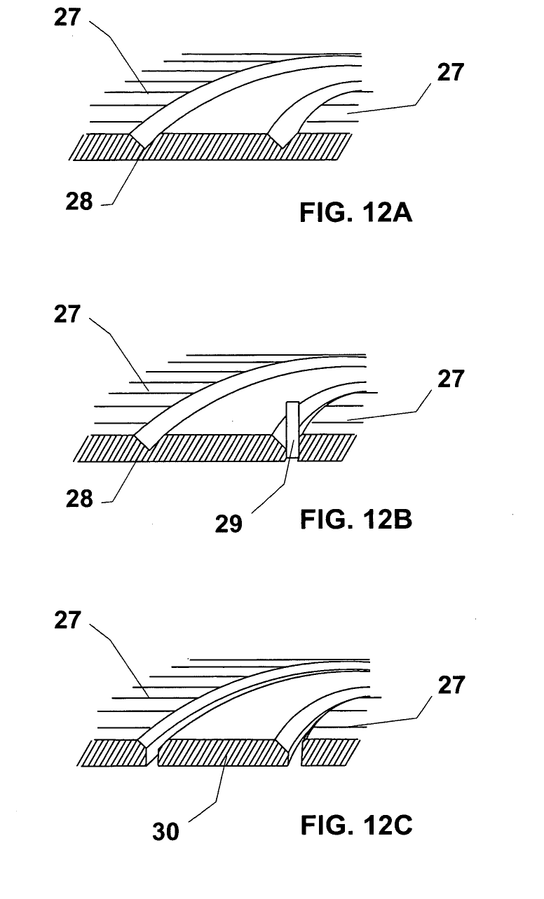

The negative spaces (27) of the designs are cut out with another tool using the centerline of the initial contour accent carving as its boundary line (28). This uses a straight or spiral cylindrical bit (29), which cuts through the entire thickness of the material. The desired decorative lattice or decorative lattice element (30) remains.(FIG. 12A, 12B, and 12C).

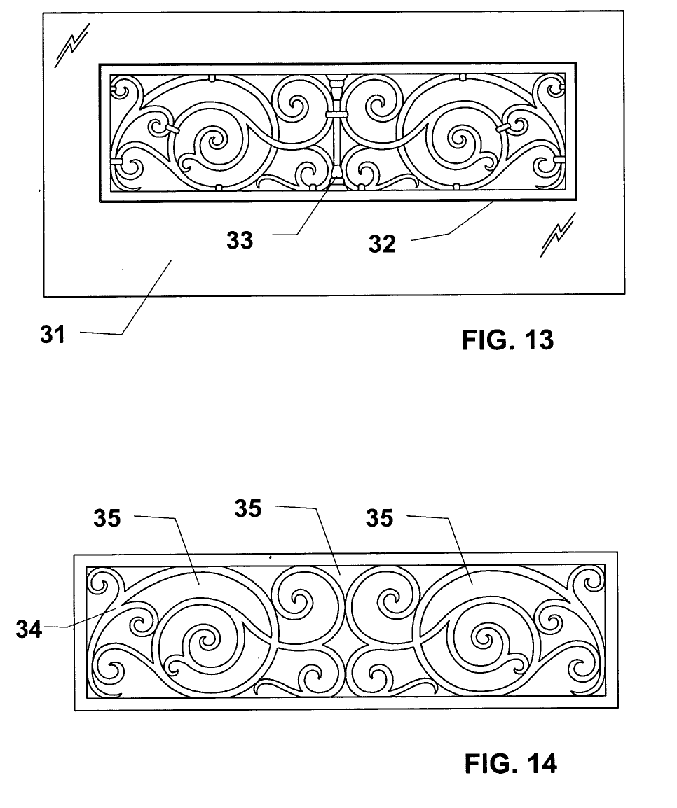

The final step is to cut the outside perimeter of the piece using the same cylindrical bit tool in order to free the decorative lattice (33) from its original board (31) along the lattice's outside perimeter (32). (FIG. 13).

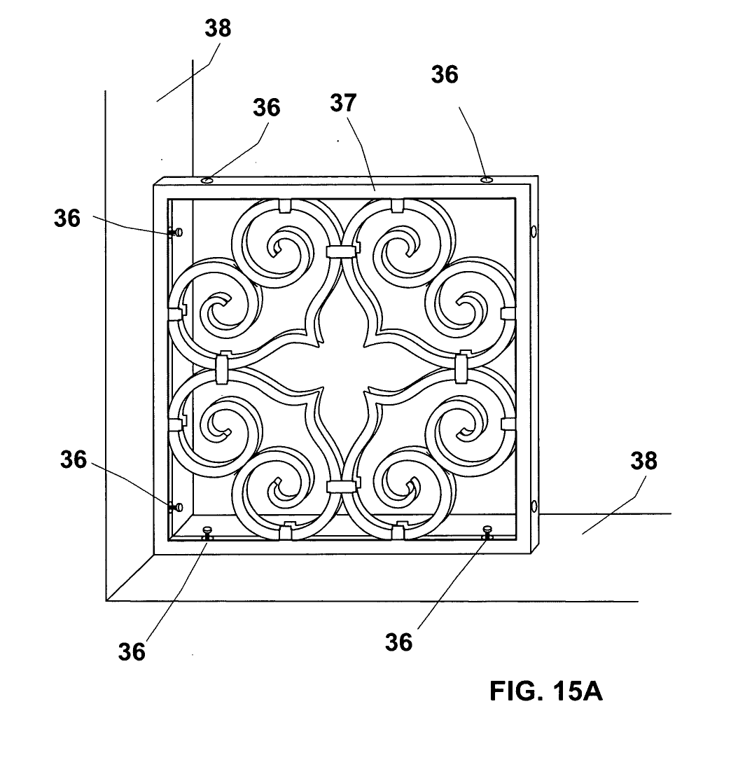

In an alternative embodiment (FIG. 14) the decorative lattices are designed and manufactured with accent carving (34) only. That is, in this alternative embodiment the negative spaces (35) are not cut-out.

Coating/Finishing

The coating material should help replicate either the material being reproduced (e.g. iron, steel, bronze, copper), the aged or oxidized form of those materials (e.g. rust, patina, tarnish) or the colors ironworks traditionally are painted in (e.g. black base and golden accents). When coated with other finishes the decorative lattice structure is made to provide the look of stone, wood, or plaster.

In a preferred embodiment the product is coated (e.g. spray, brush, and/or dip coating techniques) with different finish materials to create the desired look. For example when creating the look and feel of wrought or cast iron, the pieces are submerged into metallic solutions. The process includes applying a thin metal coating to the product. Then a catalyzing/oxidizing solution is applied to create a chemically induced oxidizing reaction (e.g. iron rust, copper/bronze patina). Alternatively an aging solution or paint is applied to create the effect of tarnished/antique metallic finishes (e.g. Antique bronze, Antique silver). The final result is an aged look of rusted iron, patina bronze, or aged silver, as desired. The product is not limited to these metal-based finishes as any other color paint and finishes may be applied. Other techniques are used in order to provide the look of stone, wood, or plaster.

Installation Hardware

Based upon the customer's desired functionality/application the product has hardware added to it.

A. Hardware for Inside Mount (within a frame or structure)

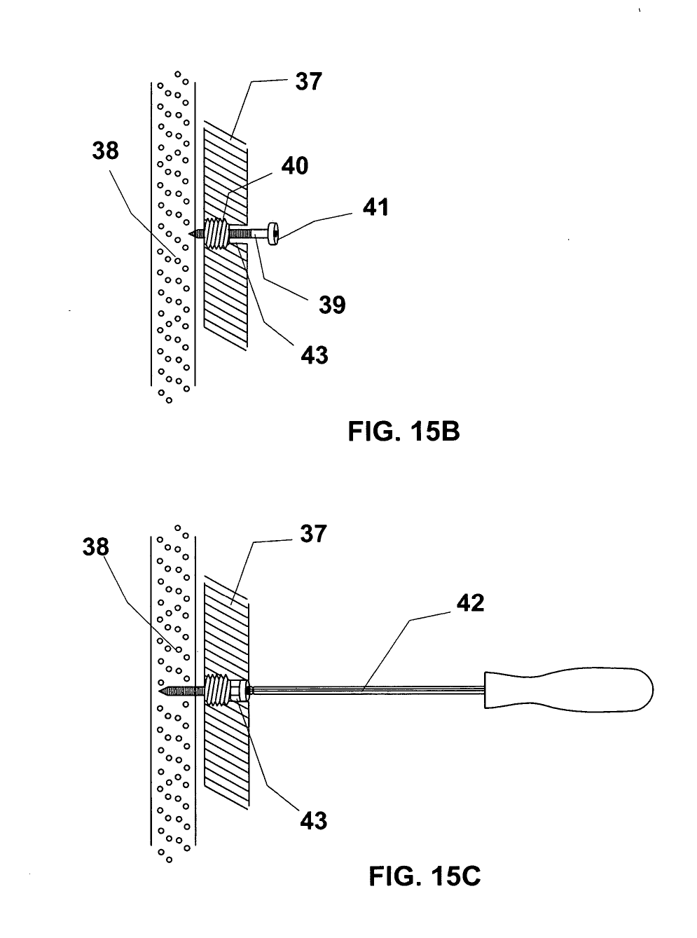

A preferred embodiment for mounting the decorative lattice within a frame (e.g. window or niche frame) (FIGS. 15A, 15B, and 15C) consists of threaded metallic inserts (40) (also know as Slotted-drive Inserts) and hex setscrews (39) (also known as Socket head cap screws). N each of these inserts and setscrews assemblies (36) are placed around the frame of the decorative lattice structure (37) to anchor the product to the frame/structure of the window (38). In reference to FIGS. 15B and 15C, the hex set screws (39) are then turned clockwise until they enter into the window (or niche) frame (38). A Hex key (42) is used for this purpose. The hex set screws are tightened until the screw head (41) become flush with the lattice's border frame (37). This is made possible because the diameter of the head of the socket head cap screw (41) is just slightly smaller than the diameter of the hole (43) used for installing the threaded metallic inserts (40), thus allowing it to be installed within that hole. The length of the screws used varies based on the width of the frame (37). It should be long enough to allow for a minimum insertion into the opening frame material (38) while short enough that when totally inserted the head stays flush with the frame's inner surface as shown on FIG. 15C.

B. Cornice Mount

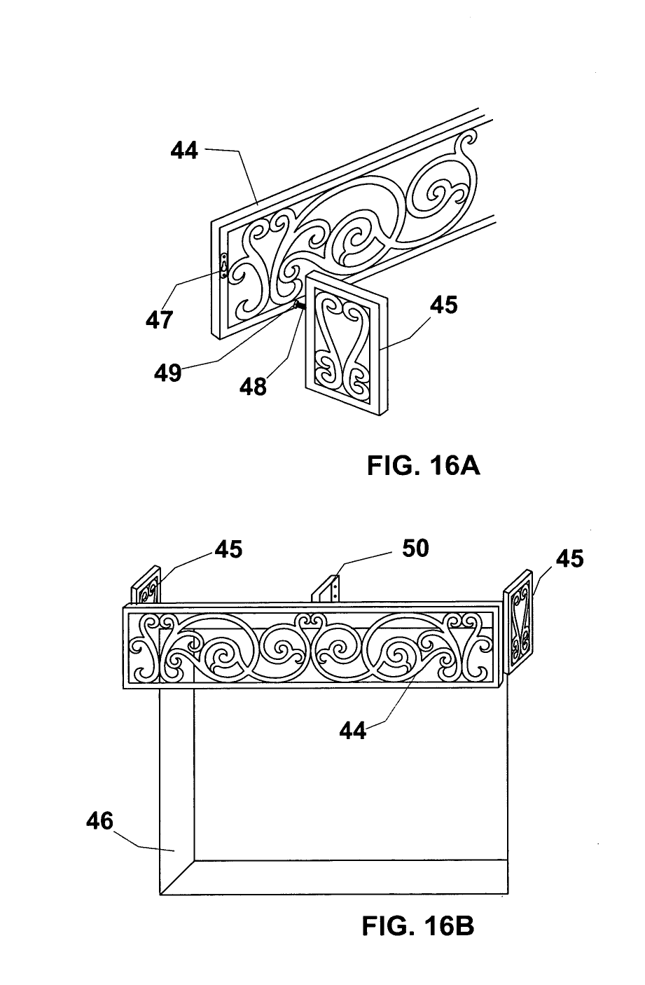

A preferred embodiment for mounting the decorative lattice as window cornice (FIGS. 16A and 16B ) consists of mounting the main/front cornice element (44) over two or more perpendicularly mounted “return elements” (45). The “return elements” are mounted to the window frame (46). The mechanical link between the “return” elements (45) and the main cornice element (44) is achieved by using keyhole hangers (47) (also known as “Keyhole fittings”) on one element and a screw (48) on the other. Assembly occurs when the screw head (49) is introduced into the keyhole fitting (47) and slid down to lock the screw into position. Additional L brackets (50) may be used to reinforce the assembly for larger pieces.

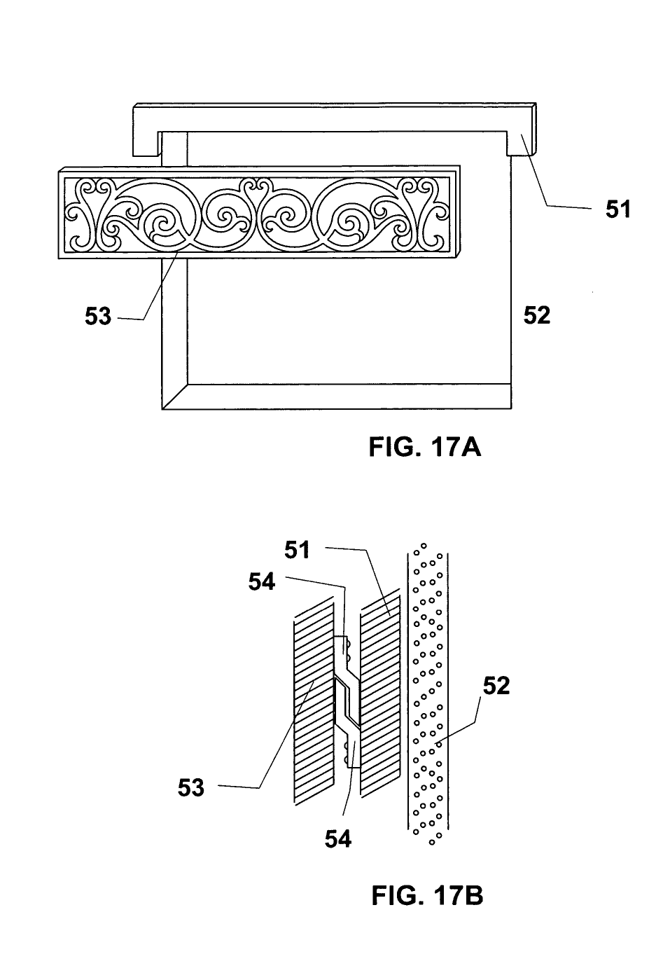

Another embodiment for mounting decorative lattices as window cornices consists of a two-part assembly (FIGS. 17A and 17B): a mounting board (51) that is attached above the window frame (52), and a decorative lattice element (53). The mechanical link between (53) and (51) is achieved by using “Z-Clip panel hangers,” (54) “Interlocking Flush mount panel hangers,” or similar hardware.

C. Other Installation Methods

Installation options depending on the application include hinges, magnets, L-Brackets, direct setscrews, spacers, hanging wires, turnbuckles.

Alternative Embodiments

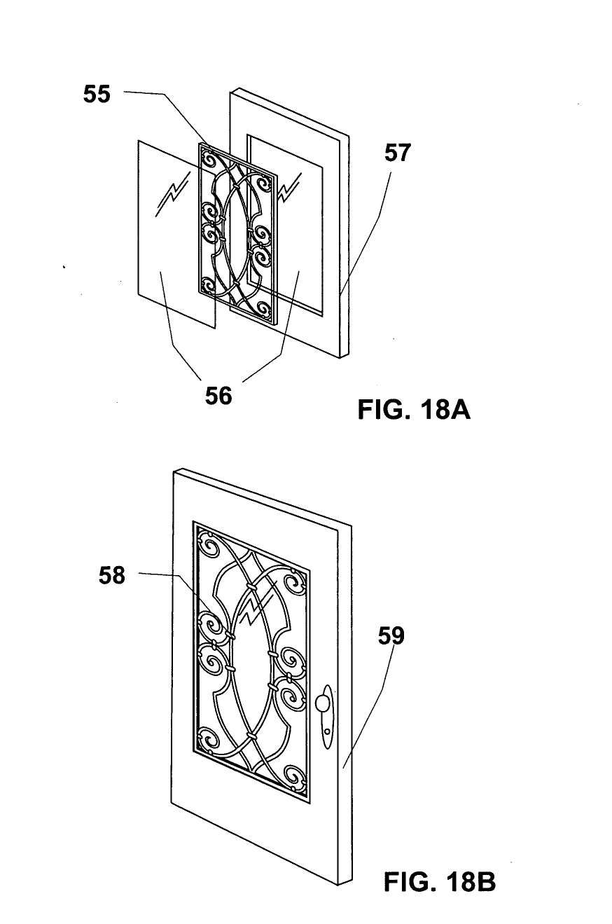

A. Assembly of invention between glass panes for use in doors and/or windows. In one embodiment, the invention can be used in the manufacturing of window or door pane assemblies, or sub-assemblies which would ultimately become part of the window/door assemblies (FIGS. 18A and 18B). In this version of the invention a finished decorative lattice (55) would be sandwiched between glass panes (56) (or similar transparent/translucent material.). A frame (57) would help hold the glass assembly together and also provide for an airtight seal of the interior of the assembly. The assembly of the “sandwich” can be performed directly into the window/door assembly or be designed as a sub-assembly (58) that is incorporated into the final assembly of windows or doors (59) at a later stage of their manufacturing/assembly process. These glass pane subassemblies could be used for the manufacturing of custom doors or windows with unique dimensions, geometry, and design requirements. Alternatively the invention can be employed for mass production by using standardized dimensions and geometry. Standard sizes and/or geometries would allow for the interchangeability of the decorative lattice assemblies. That is, window or doors could be manufactured in a way that the “decorative lattice glass assemblies” (58) would be added/assembled at the time the client selects a specific design and finish. This would also allow users the option of exchanging such “decorative lattice glass assemblies” at a later time with new assemblies incorporating different designs and finishes.

This version of the invention would probably make use of thinner sheet/board materials (⅛ to ½) but other material thickness could also be used.

Inert gasses or other type of gasses with similar characteristics can be inserted/injected within the sealed glass pane assemblies in order to displace the air within the “sandwich”. This would eliminate the potential problems related to the build up of condensate material (from the air) within the glass panels. The insertion of inert gasses would also help improve the thermal insulation capabilities of the assembly.

In order to avoid condensation build up within the glass panes it is desirable to make use of materials that do not absorb and/or emanate humidity/condensate such as certain plastic materials. Alternatively one could make use of painting/coating techniques such as powder coating or vacuum-formed plastic film in order to isolate the material to prevent the material from emanating water condensate. Another alternative when using a decorative lattice material that absorbs humidity is to put the decorative lattices through an “intense drying” process, prior to assembly within the glass panes. That can be achieved by placing the finish decorative lattices into an environment of extreme low humidity and/or submitting it to negative pressure (vacuum) to remove water from it.

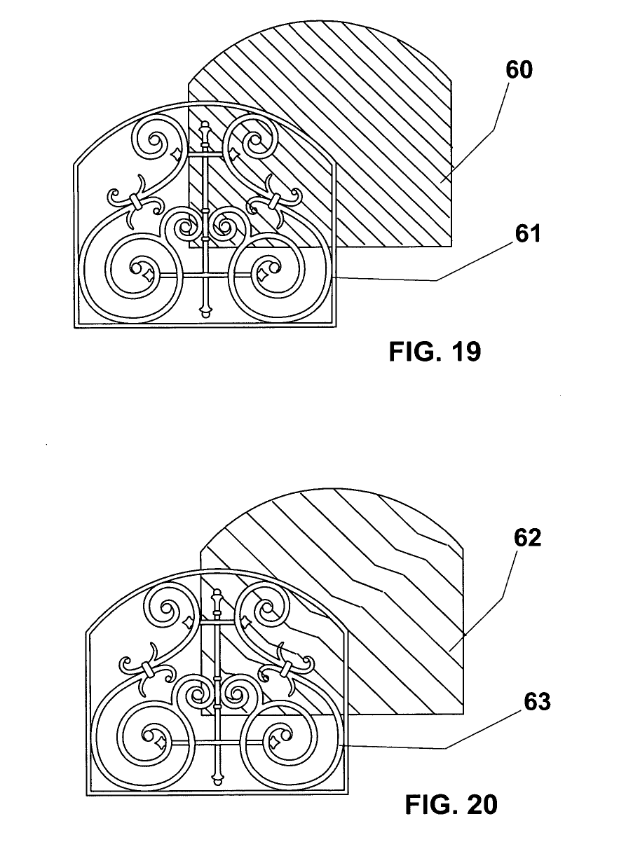

B Assembly used in conjunction with a light filtering and/or blocking materials. In yet another embodiment, the invention can be improved/enhanced for certain application by adding light filtering/blocking material to the back of the decorative lattice pieces (FIG. 19). Materials such as plastic screens, natural or synthetic fiber screens or fabrics, or/and metal screens/mesh (60) would be used to reduce the amount of light that would otherwise freely permeate through the “negative” spaces of the decorative lattices. The amount of light filtration/blocking would be determined by the tightness, spacing of the mesh/grid/screen material used. These materials would be assembled on to the back of the decorative lattice (61) using adhesives, screw, or other fastening processes.

C. Assembly of invention in conjunction with a light diffusing properties materials. Another embodiment of the invention (FIG. 20) would use the use different types of glass (62) (or glass like translucent material such as Acrylic or Plexiglas) with different types of light diffusing properties (e.g. frosted or patterned). These materials allow the permeation of light but help maintain privacy by blocking direct sight through the open “negative” spaces. These materials would be assembled on to the back of the decorative lattice (63) using adhesives, screw, or other fastening processes.

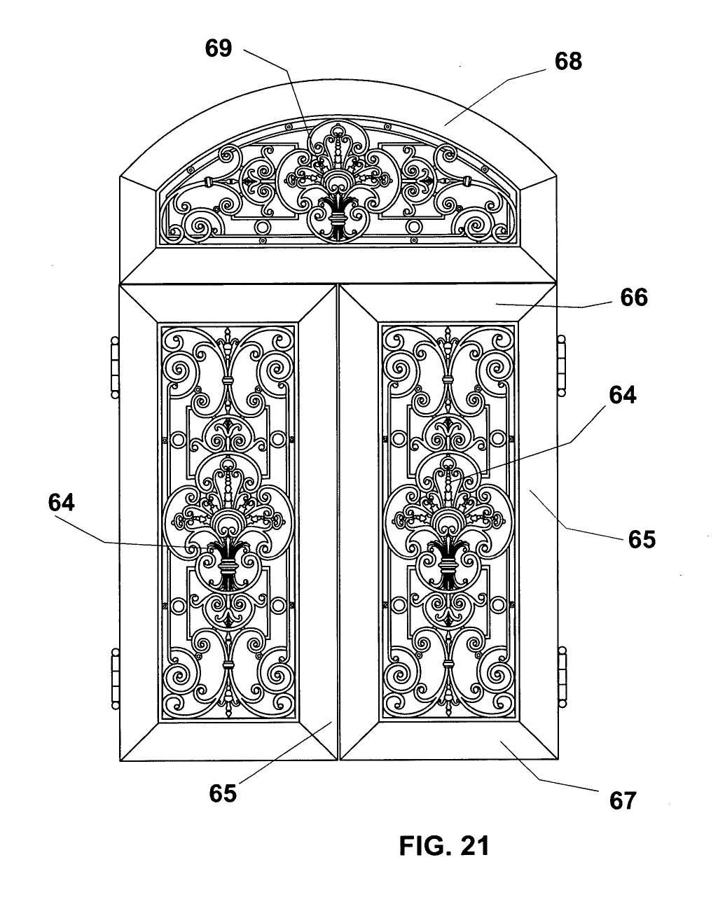

D. Assembly of invention assembled into shutter frames for use in window, door, niches. In one embodiment (FIG. 21), the invention is used in the manufacturing of shutters to be used in windows, doors, or niches. The decorative lattice (64) is assembled in place of the shutters louvers. That is, the decorative lattice would be assembled so that it is bordered by the shutter stiles (65) and the shutter top (66) and bottom rails (67) or the shutter divider rails. Shutter units that include a curved element (68) can also incorporate a decorative lattice (69) matching that shape.

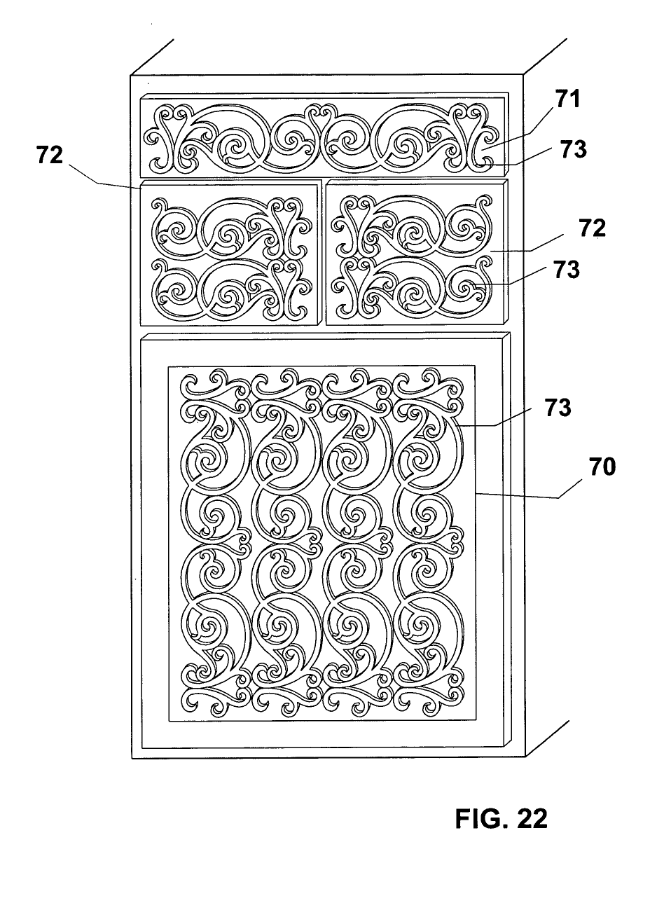

E. Assembly of invention as an accent/overlay component for furniture, cabinetry, or architectural elements. In one embodiment (FIG. 22), the invention is used as a decorative accent/overlay element for furniture, cabinetry, or architectural elements in general. In this embodiment the decorative lattice (73) is affixed over the surfaced of furniture or cabinetry or architectural elements such as panels (72), doors (70), cornices (71), and mantels. The decorative lattices are assembled on the elements by gluing, nailing, or screwing the decorative elements to the surface previously mentioned elements.

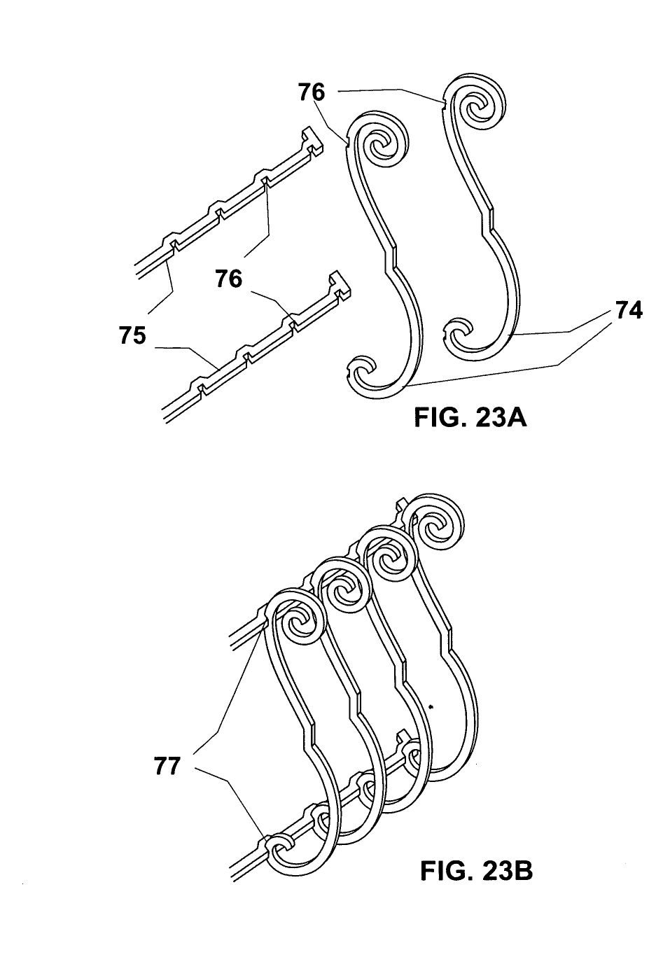

F. Use of various individual lattice design elements in building a “Compound” or “Multipart” decorative lattice. In one embodiment, various design elements are individually cut out for later assembly into more intricate/compound/multipart products that replicate complex decorative or architectural ironwork. The example shown on FIG. 23A depicts how various baluster elements (74) and horizontal rail elements (75) are individually cut. These elements include notches (76) that facilitate further assembly into more complex pieces. At assembly (FIG. 23B) the physical linkage between the elements is achieved by connecting the notches (77). The physical linkage between the elements can be further reinforced by using adhesives or fasteners. The final assembly depicted on FIG. 23B replicates a wrought iron balcony with protruding balusters.

G. Use of decorative lattices in sliding panels.

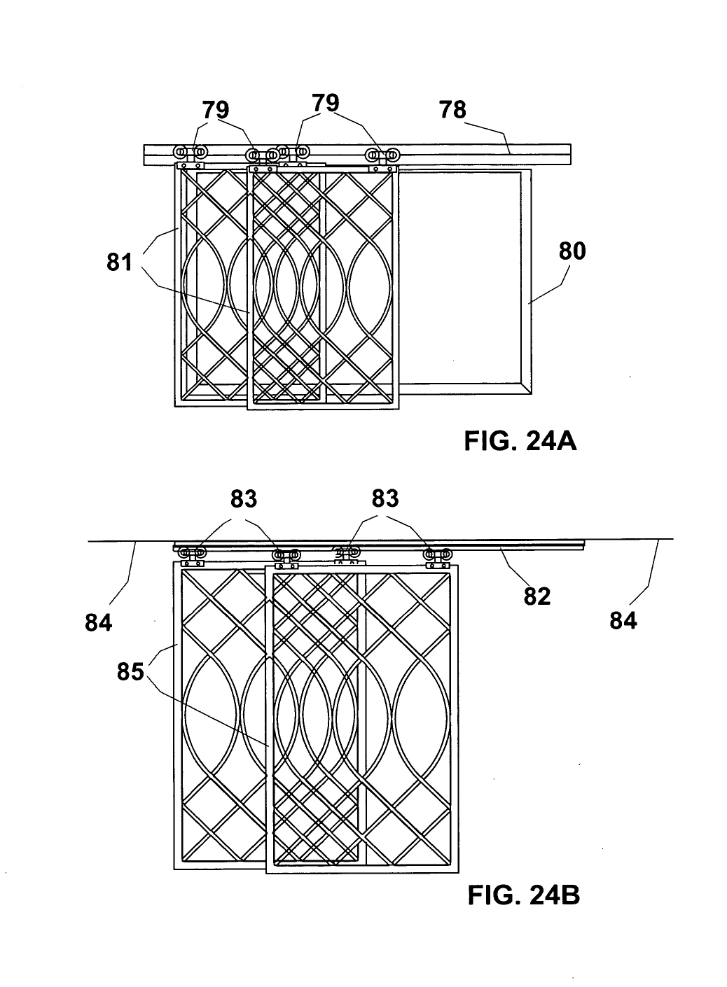

In one embodiment, the decorative lattices are built on single or multiple track assemblies as depicted on FIGS. 24A and 24B.

On FIG. 24A a multi channel track rail (78) is assembled over a window frame (80). Wheel hangers (79) are assembled on the lattice (81) upper frame. The wheel hangers (79) are assembled on the tracks (78).

On FIG. 24B a multi channel track (82) is assembled on the ceiling or beam (84) of a room. Wheel hangers (83) are assembled on the lattice (85) upper frame. The wheel hangers (83) are assembled on the tracks (82).

H. Employing powder-coating techniques in the finishing/coating process. In another embodiment the decorative lattices are coated by using powder coating techniques and equipment. Using this technique in the coating of the invention could improve some of its characteristics such as surface hardness, surface smoothness, waterproofing, and overall appearance.

I. Adding flame retardant chemicals to base material. In yet another embodiment one applies flame retardant chemicals to the decorative lattice or to the raw material (e.g. the board material), or to the paint material to improved fire resistance properties of the decorative lattice.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for creating a decorative lattice comprising:
developing a pattern using computer aided design, resulting in a CAD file;
carving said pattern into a base sheet having an outside perimeter using said CAD file, forming a front pattern on said decorative lattice;
cutting said outside perimeter to release a portion of said decorative lattice containing said front pattern; and
coating at least part of said portion of said decorative lattice with a coating to create a desired finish.

2. The method of claim 1, wherein said carving step is accomplished using a router.

3. The method of claim 2, wherein said router is fixed in a router table assembly.

4. The method of claim 3, wherein said router is guided electronically responsive to said CAD file.

5. The method of claim 4, wherein said front pattern comprises one or more elements selected from the group of: bars, scrolls, rosettes, leaves, spears curls, scrolls, rings, weaves, wrap-around bands, and wrap-around brackets, acanthus leaves, vines, flowers, leaves, fans, rosettes, bars or balusters, knobs, crosses, fleur-de-lis, and spear points.

6. The method of claim 1, wherein said base sheet is constituted of natural wood.

7. The method of claim 1, wherein said base sheet is constituted of synthetic material.

8. The method of claim 7, wherein said composite further comprises a fire retardant.

9. The method of claim 7, wherein said synthetic material is a composite comprising natural fibers and resin.

10. The method of claim 7, wherein said synthetic material is plastic.

11. The method of claim 9, wherein said plastic is ABS.

12. The method of claim 9, wherein said plastic is PVC.

13. The method of claim 9, wherein said plastic is acrylic.

14. The method of claim 1, wherein said base sheet is constituted of a compound composite material comprising metal layers.

15. The method of claim 1, further comprising cutting a rear pattern on said base sheet.

16. The method of claim 14, wherein said rear pattern is substantially identical to said front pattern.

17. The method of claim 1, further comprising assembling said decorative lattice between panes of glass.

18. The method of claim 16, further comprising assembling said decorative lattice and said panes of glass into a window or door.

19. The method of claim 1, further comprising assembling said decorative lattice with one or more materials having a light filtering or light diffusing property.

20. The method of claim 1, wherein said coating comprises a powder coating.

21. The method of claim 1, wherein said coating comprises a fire resistant coating.

22. The method of claim 1, wherein said coating simulates the appearance of metal.

23. The method of claim 1, wherein said coating simulates the appearance of iron.

24. A decorative lattice comprising:
a flat sheet of base material comprising a pattern carved into the front side, forming a front pattern on said decorative lattice, and wherein said carving is conducted responsive to a computer-aided design file;
a coating on at least part of said portion of said decorative lattice to create a desired finish.

25. The decorative lattice of claim 24, wherein said front pattern is carved using a router.

26. The decorative lattice of claim 25, wherein said router is fixed in a router table assembly.

27. The decorative lattice of claim 26, wherein said router is guided electronically.

28. The decorative lattice of claim 27, wherein said front pattern comprises elements from the group of: bars, scrolls, rosettes, leaves, spears curls, scrolls, rings, weaves, wrap-around bands, and wrap-around brackets, acanthus leaves, vines, flowers, leaves, fans, rosettes, bars or balusters, knobs, crosses, fleur-de-lis, and spear points.

29. The decorative lattice of claim 24, wherein said base sheet comprises natural wood.

29. The decorative lattice of claim 24, wherein said base sheet comprises natural wood.

30. The decorative lattice of claim 24, wherein said base sheet comprises synthetic material.

31. The decorative lattice of claim 26, wherein said synthetic material is a composite comprising natural fibers and resin.

32. The decorative lattice of claim 30, wherein said synthetic material is plastic.

33. The decorative lattice of claim 24, wherein said base sheet comprises a compound composite material comprising metal layers.

34. The decorative lattice of claim 24, wherein said base sheet further comprises a rear pattern formed by carving a rear side of said base sheet.

35. The decorative lattice of claim 34, wherein said rear pattern is substantially identical to said front pattern.

36. The decorative lattice of claim 24, further comprising a plurality of panes of glass between which the base sheet is interposed.

37. The decorative lattice of claim 24, wherein said coating comprises a powder coating.

38. The decorative lattice of claim 24, wherein said coating comprises a fire resistant coating.

39. The decorative lattice of claim 24, further comprising a lattice frame substantially surrounding the decorative lattice.

40. The decorative lattice of claim 39, further comprising threaded metallic inserts spaced around said lattice frame.

41. The decorative lattice of claim 40, further comprising hex set screws adapted to project through said threaded metallic inserts for mounting said framed decorative lattice.
